(19) United States
(12) Patent Application Publication
(10) Pub. No.: US 2010/0327087 A1
(43) Pub. Date: Dec. 30, 2010

(54) Shoulder Carried Salt Spreader

(76) Inventor: Joseph B. Harris, Englewood, NJ (US)

Correspondence Address: Law Office of Andrew Berks, 45 Wall St, Suite 2203, New York, NY, 10005, US

(21) Appl. No.: 12/491,216

(22) Filed: Jun. 24, 2009

(51) Int. Cl. E01C 19/20; A01C 15/00

(52) U.S. Cl. 239/653; 239/689; 239/154

(57) ABSTRACT

A shoulder mounted spreader for distributing salt or another granular material on the ground is provided. The device includes a shoulder carried hopper and a flexible hose for distributing the product. The inventive device has no moving parts.

### FIELD OF THE INVENTION

This invention pertains to methods of spreading granular materials on the ground with a shoulder carried device. The apparatus is useful for melting snow on walkways and roadways.

### BACKGROUND

Spreading salt for deicing is an important activity in cold-weather climates. While many mechanized devices have been developed, many individuals rely on simply cutting open a bag of salt, which is cumbersome.

Various devices have been developed to aid in the spreading of salt or other granular materials. An example is the device described in U.S. Pat. No. 6,089,477. The prior art devices, such as the invention of U.S. Pat. No. 6,089,477 (and the devices discussed in that patent) have various mechanical aids to assist in the dispensing of a particulate material. For example, U.S. Pat. No. 6,089,477 discloses an agitation means including a double ratchet assembly. The drawings include a member that appears to be an impeller. There remains a need in the art for a simpler device with no moving parts.

### SUMMARY OF THE INVENTION

This invention is a shoulder mounted apparatus for spreading a granular material, including a hopper that is carried on the back of a person with at least one shoulder strap and a flexible hose with a nozzle for dispensing the material. A typical material for the inventive apparatus is granular salt for melting ice, but in an alternative aspect, lawn care products can be dispensed.

### BRIEF DESCRIPTION OF THE DRAWINGS

FIG. 1 is a perspective view of the invention in operation.

FIGS. 2A-C are front, side, and back views.

FIGS. 3A-B are views of the nozzle

### DETAILED DESCRIPTION

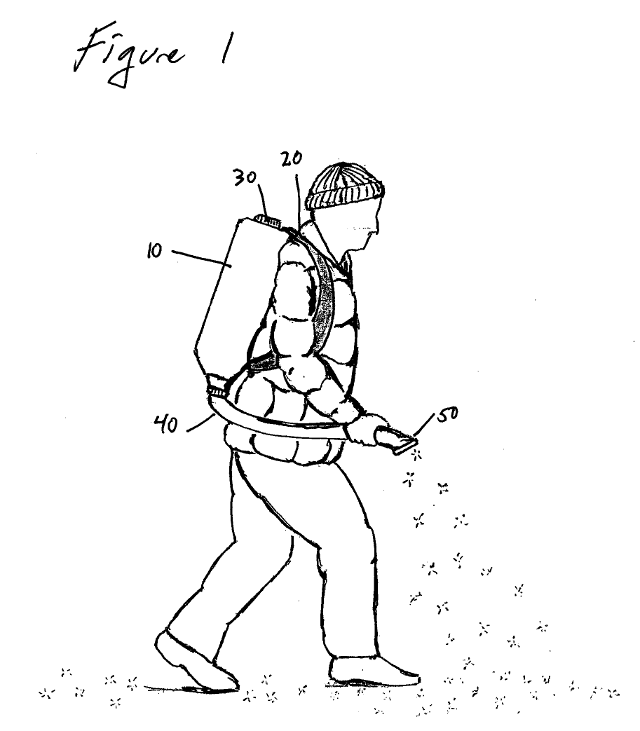

This invention includes a shoulder carried hopper designed to hold a free flowing granular material, such as salt for melting ice, grass seed, or fertilizer that can be dispensed from a flexible hose held in the hand of a person. A perspective view of the operation of the device in shown in FIG. 1. Because of the simplicity of the instant invention, the instant device is particularly suited to spreading an ice-melting composition on the ground, such as sodium chloride or calcium chloride, which may be mixed with sand or ash to aid in melting. Such ice melting compositions are sold in cold-weather climates in home supply stores, supermarkets, and the like.

In another embodiment of this invention, the hopper may be employed to dispense a lawn care product, such as grass seed, fertilizer, lime, or a pesticide. In addition, other uses can be envisioned, such as in construction for spreading or sprinkling any powdered, particulate, or granular material. The only requirement is that the material be free flowing, because no mechanism is provided in this invention for aiding in the distribution or spreading of the material.

The hopper 10 of this invention is carried on the back of an operator (i.e., a person) with at least one and preferably two shoulder straps 20. In an embodiment, the hopper may be carried similar to a backpack on the back of the operator. An opening 30 at the top of the hopper permits material to be added. The bottom of the hopper has a flexible hose 40 attached, of sufficient length that the end can be comfortably carried in the hand of the operator.

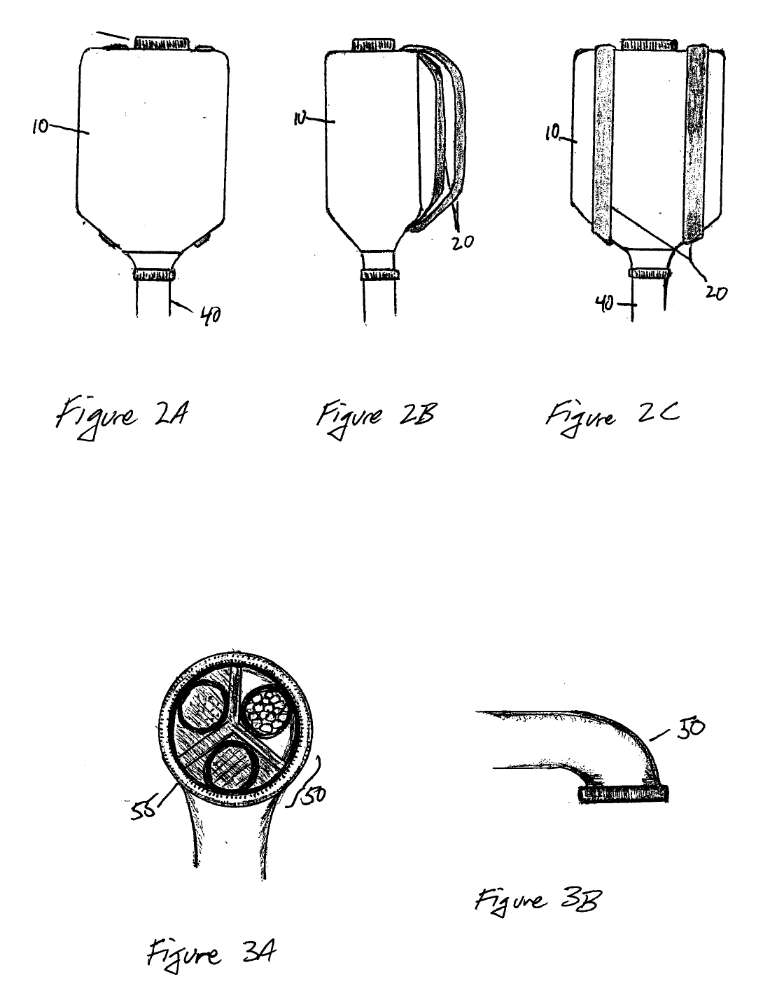

In FIG. 2, the opening 30 at the top of the hopper is shown as a screw cap, but other embodiments for the opening are within the scope of the invention, including a pop cap and an opening with no cover at all. By the term “pop cap,” it is meant that the cap is a rigid member covering the opening that is hingably affixed to the hopper, and may have a latching mechanism, such as a hook or snapping enclosure. A snapping enclosure typically has a plastic ring on the base and a slightly larger diameter ring on the cover, so that the cover fits snuggly over the opening, and wherein the cover has a tab for a finger and makes a snapping or popping sound when opened and closed.

By the term “flexible hose,” it is meant that the hose 40 can freely bend and be manipulated in the hands of the operator, without substantial narrowing of the interior diameter of the hose. Additionally, this term means that parts of the hose may be compressible, for example the distal end, to constrict the opening and allow the operator to modulate the flow of material coming out of the hose.

The distal end of the hose, that is, the end held in the hand of the operator, may have a nozzle 50 and a means for modulating the discharge of the granular material. The nozzle may comprise a simple diaphragm or flexible region that can be manually pinched off by the operator. In an alternative embodiment (illustrated in FIG. 3A), there is a rotatable member 55 with different size openings. Regardless of the embodiment, the only means for preventing the granular material from simply draining out of the hopper is the nozzle at the distal end of the hose. There is no internal mechanism for regulating the flow of the product. The apparatus of this invention has no moving parts.

As compared to the prior art, the instant invention is substantially less complex, and comprises no internal moving parts, such as ratchets, impellers, axles, levers, etc. (see U.S. Pat. No. 6,089,477). Instead, the instant invention relies purely on the flowability of the granular material being dispensed to propel the product out of the nozzle. Thus, the product is not forced out by any mechanically driven means except for the flow of gravity.

Because of the simplicity of this device, it can be manufactured as a disposable device, intended for single use and then discarded.

In other embodiments, it can be manufactured with a rigid or a flexible hopper. For example, a rigid hopper might be made from a lightweight plastic such as molded polyethylene. A flexible hopper might be made from flexible plastic, or a fabric, such as nylon or canvas. A flexible embodiment might include a frame to provide structural support.

1. A shoulder mounted apparatus for spreading a granular material onto the ground, comprising
a hopper with an opening on the top portion for storing a granular material;
at least one shoulder strap enabling a person to carry the hopper on their shoulders;
a flexible hose affixed to an opening at the bottom of the hopper; and
an adjustable nozzle at the end of the hose for modulating the flow of the granular material onto the ground.

2. The apparatus of claim 1, wherein the granular material is an ice melting composition comprising sodium chloride or calcium chloride.

3. The apparatus of claim 1, wherein the granular material is a lawn care product selected from grass seed, fertilizer, and a pesticide.

4. The apparatus of claim 1, wherein the nozzle comprises a plurality of adjustable outlets for various materials.

5. The apparatus of claim 1, wherein the nozzle comprises a flexible portion of the flexible hose, wherein said flexible portion is adapted to being pinched by the hand of the person to constrict the opening.

6. The apparatus of claim 1 with two shoulder straps.

7. The apparatus of claim 1, wherein the at least one shoulder strap is affixed to the hopper.

8. The apparatus of claim 1, wherein the hopper is flexible or rigid.

9. The apparatus of claim 1, wherein the opening has a cover or lacks a cover.

10. The apparatus of claim 1, wherein the opening has a cover comprising a screw cap or a hinged cover.
